(19) United States
(12) Patent Application Publication
(10) Pub. No.: US 2025/0220736 A1
(43) Pub. Date: Jul. 3, 2025

(54) TECHNIQUES FOR SEQUENCE NUMBERING WITH PACKET DUPLICATION AND REORDERING FOR UDP PACKETS

(71) Applicant: Lenovo (Singapore) Pte. Ltd., Singapore (SG)

(72) Inventor: Roozbeh Atarius, La Jolla, CA (US)

(21) Appl. No.: 19/086,025

(22) Filed: Mar. 20, 2025

Related U.S. Application Data
(60) Provisional application No. 63/572,554, filed on Apr. 1, 2024.

(51) Int. Cl. H04W 76/10; H04L 69/164; H04W 80/06

(52) U.S. Cl. CPC H04W 76/10; H04L 69/164; H04W 80/06

(57) ABSTRACT

Various aspects of the present disclosure relate to techniques for sequence numbering with packet duplication and reordering for user datagram protocol (UDP) packets. An apparatus is configured to establish a communication session with a user equipment (UE), the communication session comprising multi-path quick UDP internet connection (MPQUIC) functionality; enable steering, switching, and splitting of UDP traffic between the UE and a proxy using the MPQUIC functionality; and transmit UDP packets between the UE and the proxy, the UDP packets encapsulated within datagram frames comprising an indication of an order of the datagram frames.

### TECHNICAL FIELD

The present disclosure relates to wireless communications, and more specifically to techniques for sequence numbering with packet duplication and reordering for user datagram protocol (UDP) packets.

### BACKGROUND

A wireless communications system may include one or multiple network communication devices, such as base stations or other network equipment (NE), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

In one embodiment, an apparatus may be configured to support a means to establish a communication session with a UE, the communication session comprising multi-path quick user datagram protocol (UDP) internet connection (MPQUIC) functionality; enable steering, switching, and splitting of UDP traffic between the UE and a proxy using the MPQUIC functionality; and transmit UDP packets between the UE and the proxy, the UDP packets encapsulated within datagram frames comprising an indication of an order of the datagram frames.

In one embodiment, a method may be configured to support a means to establish a communication session with a UE, the communication session comprising MPQUIC functionality; enable steering, switching, and splitting of UDP traffic between the UE and a proxy using the MPQUIC functionality; and transmit UDP packets between the UE and the proxy, the UDP packets encapsulated within datagram frames comprising an indication of an order of the datagram frames.

In one embodiment, a processor may be configured to support a means to establish a communication session with a UE, the communication session comprising MPQUIC functionality; enable steering, switching, and splitting of UDP traffic between the UE and a proxy using the MPQUIC functionality; and transmit UDP packets between the UE and the proxy, the UDP packets encapsulated within datagram frames comprising an indication of an order of the datagram frames.

In one embodiment, an apparatus may be configured to support a means to establish a communication session with a proxy via a NE, the communication session comprising MPQUIC functionality, wherein steering, switching, and splitting of UDP traffic between the UE and a proxy is enabled using the MPQUIC functionality.

In one embodiment, a method may be configured to support a means to establish a communication session with a proxy via a NE, the communication session comprising MPQUIC functionality, wherein steering, switching, and splitting of UDP traffic between the UE and a proxy is enabled using the MPQUIC functionality.

In one embodiment, a processor may be configured to support a means to establish a communication session with a proxy via a NE, the communication session comprising MPQUIC functionality, wherein steering, switching, and splitting of UDP traffic between the UE and a proxy is enabled using the MPQUIC functionality.

### BRIEF DESCRIPTION OF THE DRAWINGS

FIG. 1 illustrates an example of a wireless communications system in accordance with aspects of the present disclosure.

FIG. 2 illustrates an example of multi-access protocol data unit (MA PDU) session establishment in accordance with aspects of the present disclosure.

FIG. 3 illustrates an example of the relation between HTTP/3 datagram and UDP proxying HTTP diagram payload in accordance with aspects of the present disclosure.

FIG. 4 illustrates an example of the relation between true UDP proxying payload and UDP proxying HTTP datagram payload in accordance with aspects of the present disclosure.

FIG. 5 illustrates an example of one embodiment of the sequence number in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a NE in accordance with aspects of the present disclosure.

FIG. 10 illustrates a flowchart of a method performed by a UE in accordance with aspects of the present disclosure.

### DETAILED DESCRIPTION

Generally, the subject matter herein is directed to techniques for sequence numbering with packet duplication and reordering for UDP packets. Apparatuses, methods, systems, devices, processors, and/or the like are configured to perform various functions for sequence numbering with packet duplication and reordering for UDP packets.

In some cases, higher-layer steering functionality can use multipath quick UDP internet connection (MPQUIC) to enable steering, switching, and splitting of UDP traffic between the UE and the user plane function (UPF) in an Access Traffic Steering, Switching, Splitting (ATSSS) feature (e.g., as described in 3GPP TS 23.501 (incorporated herein by reference)). In certain cases, two transport modes are available when the steering functionality is MPQUIC functionality-“Datagram mode 1” and “Datagram mode 2” (e.g., as described in 3GPP TS 24.501 (incorporated herein by reference)). For example, the “Datagram mode 1” transport mode may require sequence numbering for the UDP packets within the QUIC datagram frames (e.g., as defined in IETF RFC 9221 (incorporated herein by reference)). The subject matter herein addresses the order numbering of the UDP packets encapsulated in the QUIC datagram frames.

In one embodiment, the solutions described herein provide an indicator (e.g., a sequence number) as a first octet of a payload of QUIC datagram frames, which indicates the size of the number of bits for numbering the order, followed by the number. In one embodiment, one or more of the datagram frames is received from a different source, e.g., different access technologies that are used to transmit a datagram frame (e.g., a transmitter that uses 3GPP and non-3GPP radio access technologies to transmit datagram frames). In certain embodiments, the solutions describe predetermining the size of the number of bits, where the number is used to determine the order of the QUIC datagram frames by negotiation in prior to UDP packet transmission and/or by a decision, e.g., such as network provider's decision.

The solutions described herein may be performed by a UE and/or an NE (or a network function) and impact communications between a UE and an NE. Accordingly, in certain embodiments, the solutions described herein enhance the reliability, efficiency, and robustness of wireless communications between a UE and an NE, and specifically wireless communications that use UDP packet transmission. Aspects of the present disclosure are described in the context of a wireless communications system.

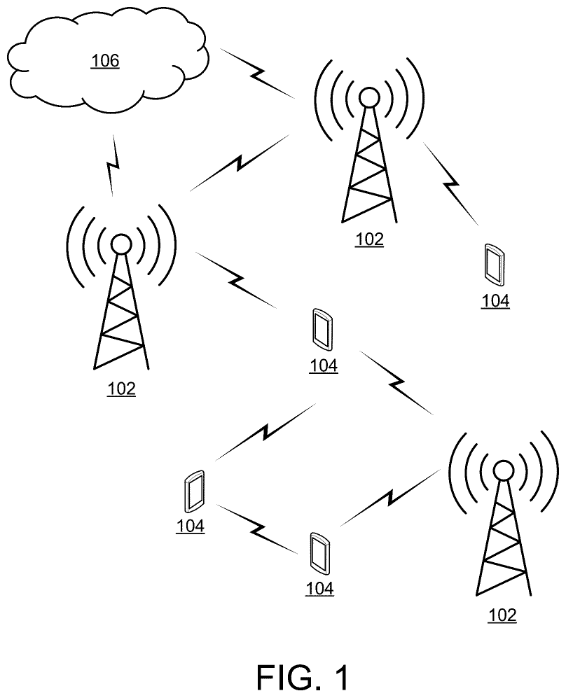

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, a NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHz), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the functionality in an ATSSS-capable UE that allows for steering, switching, and splitting the multiple access (MA) PDU session traffic across 3GPP access and non-3GPP access is called “steering functionality.” An ATSSS-capable UE may support high-layer steering functionalities, which operate above the IP layer (e.g., as described in 3GPP TS 23.501 (incorporated herein by reference)) having two high-layer steering functionalities where:

the first high layer steering functionality applies the multipath transmission control protocol (MPTCP) protocol (e.g., IETF RFC 8684, incorporated herein by reference) and is referred to as “MPTCP functionality” (see clause 5.32.6.2.1 of 3GPP TS 23.501). This steering functionality can be applied to steer, switch, and split the TCP traffic flows identified in the ATSSS rules, e.g., as defined in clause 5.32.8 of 3GPP TS 23.501. The MPTCP functionality in the UE may communicate with an associated MPTCP proxy functionality in the UPF, by using the MPTCP protocol over the 3GPP and/or the non-3GPP user plane; and

the second high layer steering functionality applies the QUIC protocol (e.g., described in IETF RFC 9000, IETF RFC 9001, IETF RFC 9002, each incorporated herein by reference) and its multipath extensions, and is referred to as “MPQUIC functionality” (see clause 5.32.6.2.2 of 3GPP TS 23.501). This steering functionality can be applied to steer, switch, and split the UDP traffic flows identified in the ATSSS rules, e.g., as defined in clause 5.32.8 of 3GPP TS 23.501. The MPQUIC functionality in the UE may communicate with an associated MPQUIC proxy functionality in the UPF, by using the QUIC protocol and its multipath extensions over the 3GPP and/or the non-3GPP user plane.

In one embodiment, an ATSSS-capable UE may support low-layer steering functionalities, which operate below the IP layer. One type of low-layer steering functionality is referred to as “ATSSS Low-Layer functionality” (ATSSS-LL) (see clause 5.32.6.3.1 of 3GPP TS 23.501). This steering functionality can be applied to steer, switch, and split various types of traffic, including TCP traffic, UDP traffic, Ethernet traffic, or the like. For example, ATSSS-LL functionality may be mandatory for Ethernet MA PDU Sessions. In the network, there may be one UPF supporting ATSSS-LL in the data path of the MA PDU session.

In one embodiment, the MPQUIC functionality enables steering, switching, and splitting of UDP traffic between the UE and UPF, in accordance with the ATSSS policy, which the network may create. The operation of the MPQUIC functionality may be based on IETF RFC 9298 (incorporated herein by reference), which specifies how UDP traffic can be transferred between a client (UE) and a proxy (UPF) using the HTTP/3 protocol IETF RFC 9114 (incorporated herein by reference). The HTTP/3 protocol operates on top of the QUIC protocol (IETF RFC 9000, IETF RFC 9001, IETF RFC 9002), which supports simultaneous communication over multiple paths.

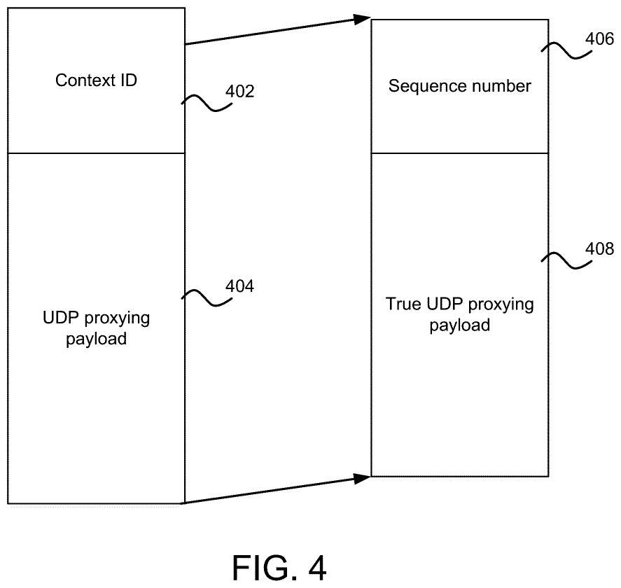

The MPQUIC functionality may be enabled for an MA PDU Session with type IPv4, IPv6 or IPv4v6, when both the UE and the network support this functionality. The MPQUIC functionality may not be enabled when the type of the MA PDU Session is Ethernet. In one embodiment, the MPQUIC functionality in the UE communicates with the MPQUIC Proxy functionality in the UPF (see FIG. 4.2.10-1 of 3GPP TS 23.501) using the user plane of the 3GPP access, or the non-3GPP access, or both.

In one embodiment, the MPQUIC functionality is composed of three components—a Quality of Service (QOS) flow selection and steering mode selection, an HTTP/3 layer, and a QUIC layer.

In QoS flow selection and steering mode selection, the UE initiates the establishment of one or more multipath QUIC connections, after the establishment of the MA PDU session and, for each uplink UDP flow, it selects a QoS flow (e.g., based on the QoS rules), a steering mode, and a transport mode (e.g., based on the ATSSS rules). This component in the UPF selects, for each downlink UDP flow, a QoS flow, a steering mode, and a transport mode. In the UE, this component is used in the uplink direction, while, in the UPF, this component is used in the downlink direction.

The HTTP/3 layer supports the HTTP/3 protocol, (e.g., as defined in RFC 9114 (incorporated herein by reference)) and the extensions defined in IETF RFC 9298 (incorporated herein by reference) for supporting UDP proxying over HTTP, IETF RFC 9297 (incorporated herein by reference) for supporting HTTP datagrams, and IETF RFC 9220 (incorporated herein by reference) for supporting Extended CONNECT. The HTTP/3 layer selects a multipath QUIC connection to be used for each UDP flow and allocates a new QUIC stream on this connection that is associated with the UDP flow. It also configures this QUIC stream to apply a specific steering mode. In the UE, the HTTP/3 layer implements an HTTP/3 client, while, in the UPF, it implements an HTTP/3 proxy.

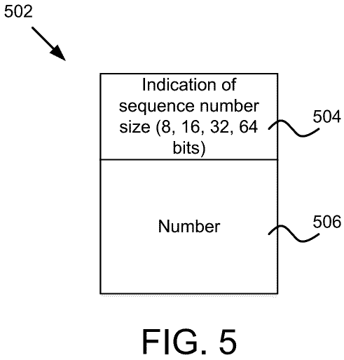

The QUIC layer supports the QUIC protocol as defined in the applicable IETF specifications (e.g., IETF RFC 9000, IETF RFC 9001, and IETF RFC 9002) and the extensions defined in RFC 9221 (incorporated herein by reference) for supporting unreliable datagram transport with QUIC and for supporting QUIC connections using multiple paths simultaneously. FIG. 5.32.6.2.2-1 of 3GPP TS 23.501 shows the protocol stack of the user plane when the MPQUIC functionality is applied.

In one embodiment, if the UE indicates that it is capable of supporting the MPQUIC functionality, and the network agrees to enable the MPQUIC functionality for the MA PDU session then an associated MPQUIC proxy functionality is enabled in the UPF for the MA PDU session.

In such an embodiment, the network allocates one IP address/prefix for the MA PDU session to the UE and two additional IP addresses/prefixes, referred to as “MPQUIC link-specific multipath” addresses/prefixes-one associated with 3GPP access and another associated with the non-3GPP access. In the UE, these two IP addresses/prefixes are used by the MPQUIC functionality. Each “MPQUIC link-specific multipath” address/prefix assigned to UE may not be routable via an N6 reference point. The MPQUIC functionality in the UE and the MPQUIC proxy functionality in the UPF may use the “MPQUIC link-specific multipath” addresses/prefixes for transmitting UDP flows over non-3GPP access and over 3GPP access. The MPQUIC proxy functionality may use the IP address/prefix of the MA PDU session for the communication with the final destination.

Further, the network sends MPQUIC proxy information to the UE, e.g., an IP address of the UPF, a UDP port number, and the proxy type (e.g., “connect-udp”). This information may be used by the UE for establishing multipath QUIC connections with the UPF, which implements the MPQUIC Proxy functionality.

In addition, after the MA PDU Session is established, the UE determines the number of multipath QUIC connections to be established with the UPF. The UE determines to establish at least as many multipath QUIC connections as the number of QoS flows of the MA PDU Session, e.g., one multipath QUIC connection per QoS flow. Each multipath QUIC connection carries the UDP traffic mapped to a single QoS flow.

In one embodiment, during QUIC connection establishment, the UE and UPF negotiate QUIC transport parameters and indicate support of QUIC datagram frames and support of multipath. They indicate support of QUIC datagram frames by providing the “max_datagram_frame_size” transport parameter with a non-zero value (scc, e.g., IETF RFC 9221) and they indicate support of multipath by providing the “enable_multipath” transport parameter. In addition, during QUIC connection establishment, the QoS flow associated with this connection is determined. The UE sends the traffic of the QUIC connection over the QoS flow associated with the QUIC connection. This may enable the UPF to determine the QoS flow associated with the QUIC connection and to select a QUIC connection for sending the downlink traffic of a QoS flow.

After QUIC connection establishment, in some cases, the HTTP/3 client in the UE and the HTTP/3 proxy in the UPF negotiate HTTP settings and indicate support of HTTP datagrams (see, e.g., IETF RFC 9297) and support of Extended CONNECT (see, e.g., IETF RFC 9220). To use MPQUIC proxying for a UDP traffic flow, the UE sends a HTTP/3 CONNECT request (see, e.g., IETF RFC 9298) to the HTTP/3 proxy in the UPF.

The network may indicate to the UE the list of applications for which the MPQUIC functionality should be applied by using the steering functionality component of an ATSSS rule (scc, e.g., clause 5.32.8 of 3GPP TS 23.501).

In some cases, the MPQUIC functionality supports various transport modes for transmitting a UDP flow between UE and UPF, see, e.g., 3GPP TS 23.501. The PCF may select which of the transport modes will be applied to a UDP flow. The selected transport mode is provided to UE and UPF within the ATSSS rules.

The datagram mode 1 transport mode (which may be an extension of the mode defined in RFC 9298) encapsulates UDP packets within QUIC datagram frames and provides unreliable transport but with sequence numbering and with packet reordering or deduplication. It can be applied for various UDP flows.

The datagram mode 2 transport mode (e.g., defined in RFC 9298) encapsulates UDP packets within QUIC datagram frames and provides unreliable transport with no sequence numbering and no packet reordering or deduplication.

The solutions described herein are generally directed to determining the order numbering of the UDP packets encapsulated in the QUIC datagram frames. In one embodiment, the solutions describe using an indicator as the first octet of the payload of the QUIC datagram frames, indicating the size of the number of bits for numbering the order, followed by the number. In certain embodiments, the solutions describe predetermining the size of the number in bits, where the number is used to determine the order of the QUIC datagram frames by negotiation in prior to UDP packet transmission and/or a decision such as network providers decision.

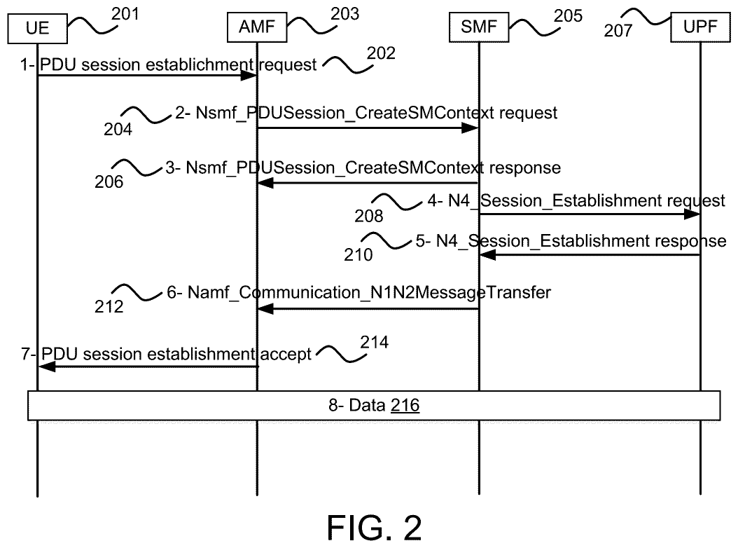

FIG. 2 illustrates an example of MA PDU session establishment in accordance with aspects of the present disclosure. In particular, FIG. 2 shows a UE-requested PDU session establishment (with the assumption that the UE is already registered to the network).

At 1 (see messaging 202), in one embodiment, the UE 201 initiates the PDU session establishment procedure by including several information elements within the NAS message for the PDU session establishment procedure.

At 2 (see messaging 204), in one embodiment, upon determining the session management function (SMF) 205, the AMF 203 constructs a Nsmf_PDUSession_CreateSMContext request with information elements to create a session management (SM) context.

At 3 (see messaging 206), in one embodiment, upon creating the SM context, the SMF 205 informs the AMF 203 by an Nsmf_PDUSession_CreateSMContext response.

At 4 (see messaging 208), in one embodiment, the SMF 205 initiates the N4 Session establishment procedure with the UPF 207 by sending N4 rules derived by SMF 205 for the MA PDU session to instruct the UPF 207 to activate the MPQUIC functionality for this MA PDU Session.

At 5 (see messaging 210), in one embodiment, the UPF 207 allocates the UE 201 “MPQUIC link-specific multipath” addresses/prefixes and sends the “MPQUIC link-specific multipath” addresses/prefixes and MPQUIC proxy information to the SMF 205.

At 6 (see messaging 212), in one embodiment, the SMF 205 includes an “MA PDU session Accepted” indication in the Namf_Communication_NIN2MessageTransfer message to the AMF 203 and indicates to AMF 203 that the N2 SM Information included in this message should be sent to the UE 201. The AMF 203 marks this PDU session as MA PDU session based on the received “MA PDU session Accepted” indication.

At 7 (see messaging 214), in one embodiment, the UE 201 receives a PDU session establishment accept message, which indicates to the UE 201 that the requested MA PDU session was successfully established. This message includes the ATSSS rules for the MA PDU session, which were derived by SMF 205 and the “MPQUIC link-specific multipath” addresses/prefixes of the UE 201 and the MPQUIC proxy information.

At 8 (see block 216), in one embodiment, the uplink and downlink data is established for the MA PDU session with the UDP packets transmitting between the UE 201 and the UPF 207.

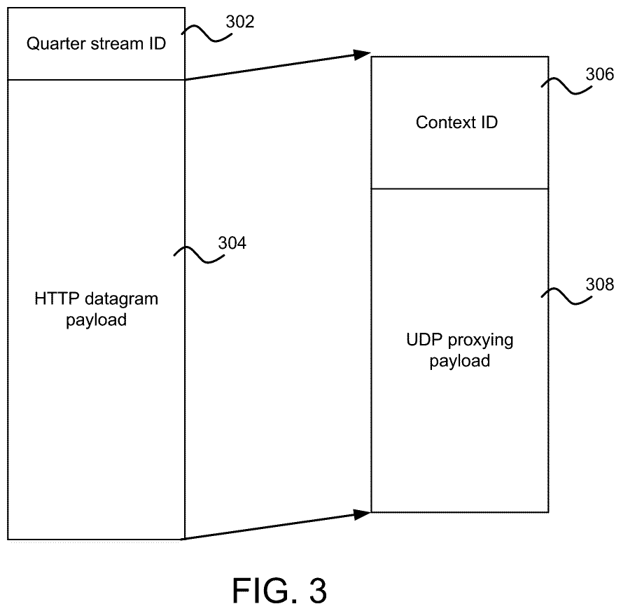

FIG. 3 illustrates an example of the relation between HTTP/3 datagram and UDP proxying HTTP diagram payload in accordance with aspects of the present disclosure. In one embodiment, in the data connection, the QUIC datagram frame can be used to provide demultiplexing and unreliable delivery, when HTTP datagrams are conveyed on an HTTP/3 connection. When used with HTTP/3, in one embodiment, the datagram data field of QUIC datagram frames uses the following format:

```
HTTP/3 datagram {
  Quarter stream ID (i),
  HTTP datagram payload (..),
}
```

where quarter stream ID 302 is a variable-length integer representing the value of the client-initiated bidirectional stream that the datagram is associated with, divided by four, e.g., see IETF RFC 9297. In one embodiment, the HTTP datagram payload 304, which is a QUIC datagram frame payload, is the payload of the HTTP/3 datagram, that has semantics that are defined by the extension that uses HTTP datagrams.

In one embodiment, when HTTP datagrams are associated with UDP proxying request streams, the HTTP datagram payload field has the following format:

```
UDP proxying HTTP datagram payload {
  Context ID (i),
  UDP proxying payload (..),
}
```

where context ID 306 is 62-bits that are encoded with variable-length integers, e.g., defined in clause 16 of IETF RFC 9000. In one embodiment, two transport modes are defined when the steering functionality is MPQUIC functionality, and they are identified by “Datagram mode 1” and “Datagram mode 2” (see, e.g., 3GPP TS 24.501). In one embodiment, datagram mode 1 uses sequence numbering for the UDP packets and is identified when the bits of the context ID are set to values that are greater than zero, e.g., all set to the value “1”, or the like. In one embodiment, datagram mode 2 does not require sequence numbering for the UDP packets and is identified when the bits of the context ID are set to the value “0”. In one embodiment, UDP proxying payload 308 is the payload of the UDP proxying HTTP datagram.

FIG. 4 illustrates an example of the relation between true UDP proxying payload and UDP proxying HTTP datagram payload in accordance with aspects of the present disclosure. In one embodiment, for the sequence number 406 of the MPQUIC datagram frame payload, when the steering functionality is MPQUIC functionality and the transport mode is datagram mode 1, meaning all 62-bits of the context ID 402 are set to a value greater than zero, e.g., the value “1”, an 8, 16, 32, or 64 bit unsigned integer may be used. In one embodiment, the true UDP proxying payload 408 is the payload of the UDP proxying HTTP datagram. In one embodiment, the UDP proxying payload field 404 may have the format:

```
UDP proxying payload {
  Sequence number of 8, 16, 32, or 64 bits,
  True UDP proxying payload (..),
}
```

FIG. 5 illustrates an example of one embodiment of the sequence number in accordance with aspects of the present disclosure. In one embodiment, a sequence number 502 may be indicated using 8, 16, 32, or 64 bits. In such an embodiment, the first octet 504 of the sequence number 502 may be an indicator for the size of the sequence number 502, where the remaining bits 506 represent the actual sequence number, as shown by the following format:

```
Sequence number {
  Size of 8, 16, 32, or 64 bits,
  Number (..),
}
```

In one embodiment, the size may always be one value, meaning either 8, 16, 32, or 64 for the ATSSS feature when MPQUIC is the steering functionality. In such an embodiment, the indication of the size for the sequence number may not be needed.

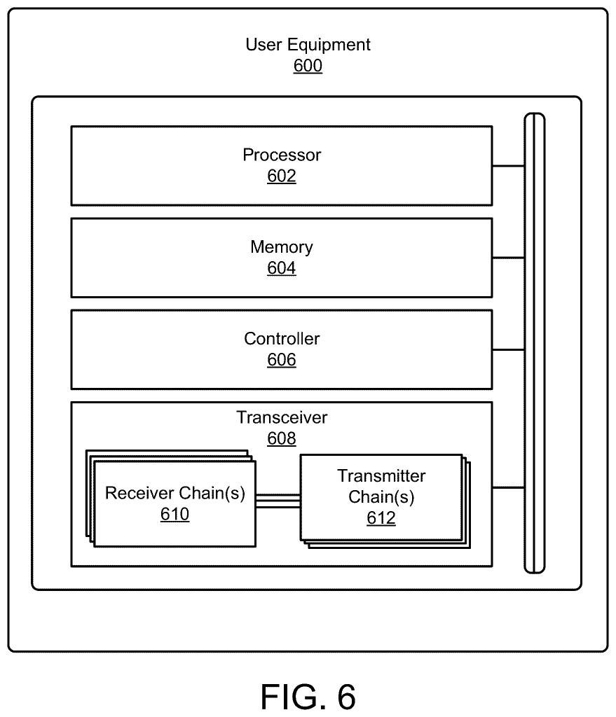

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for order numbering of the UDP packets encapsulated in the QUIC datagram frames.

In one embodiment, the UE 600 may be configured to support a means to establish a communication session with a UE, the communication session comprising MPQUIC functionality, enable steering, switching, and splitting of UDP traffic between the UE and a proxy using the MPQUIC functionality, and transmit UDP packets between the UE and the proxy, the UDP packets encapsulated within datagram frames comprising an indication of an order of the datagram frames.

In one embodiment, the indication of the order of the datagram frames is included in each datagram frame. In one embodiment, the indication of the order of the datagram frames is predetermined prior to transmitting the datagram frames.

In one embodiment, the indication of the order of the datagram frames that is predetermined prior to transmitting the datagram frames is not included in the datagram frames, and wherein a value determined based on a number of bits is used for numbering the order of the datagram frames.

In one embodiment, the UE is an ATSSS device. In one embodiment, the communication session comprises an MA PDU session. In one embodiment, one or more of the datagram frames is received from a different source and ordered according to the indication.

In one embodiment, the indication in each of the datagram frames is located at a first octet after a context ID within the payload of each of the datagram frames, wherein the indication comprises a 32-bit integer set to a value that is greater than 0. In one embodiment, the indication in each of the datagram frames comprises a value determined based on a number of bits used for numbering the order of the datagram frames.

In one embodiment, a transport mode is used to transmit the UDP packets. In one embodiment, the transport mode is datagram mode 1. In one embodiment, the proxy is a UPF. In one embodiment, the datagram frames are QUIC datagram frames.

In one embodiment, the UE 600 may be configured to support a means to establish a communication session with a proxy via a NE, the communication session comprising MPQUIC functionality, wherein steering, switching, and splitting of UDP traffic between the UE and a proxy is enabled using the MPQUIC functionality. In one embodiment, the UE 600 may be configured to support a means to transmit UDP packets to the proxy, the UDP packets encapsulated within datagram frames comprising an indication of an order of the datagram frames.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

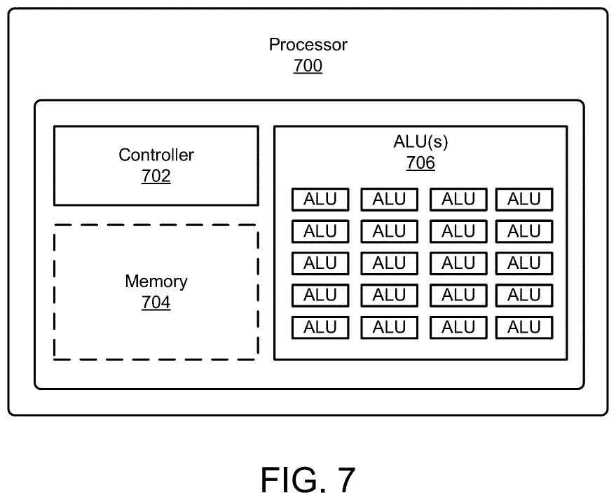

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for order numbering of the UDP packets encapsulated in the QUIC datagram frames.

In one embodiment, the processor 700 may be configured to support a means to establish a communication session with a UE, the communication session comprising MPQUIC functionality, enable steering, switching, and splitting of UDP traffic between the UE and a proxy using the MPQUIC functionality, and transmit UDP packets between the UE and the proxy, the UDP packets encapsulated within datagram frames comprising an indication of an order of the datagram frames.

In one embodiment, the indication of the order of the datagram frames is included in each datagram frame. In one embodiment, the indication of the order of the datagram frames is predetermined prior to transmitting the datagram frames.

In one embodiment, the indication of the order of the datagram frames that is predetermined prior to transmitting the datagram frames is not included in the datagram frames, and wherein a value determined based on a number of bits is used for numbering the order of the datagram frames.

In one embodiment, the UE is an ATSSS device. In one embodiment, the communication session comprises an MA PDU session. In one embodiment, one or more of the datagram frames is received from a different source and ordered according to the indication.

In one embodiment, the indication in each of the datagram frames is located at a first octet after a context ID within the payload of each of the datagram frames, wherein the indication comprises a 32-bit integer set to a value that is greater than 0. In one embodiment, the indication in each of the datagram frames comprises a value determined based on a number of bits used for numbering the order of the datagram frames.

In one embodiment, a transport mode is used to transmit the UDP packets. In one embodiment, the transport mode is datagram mode 1. In one embodiment, the proxy is a UPF. In one embodiment, the datagram frames are QUIC datagram frames.

In one embodiment, the processor 700 may be configured to support a means to establish a communication session with a proxy via a NE, the communication session comprising MPQUIC functionality, wherein steering, switching, and splitting of UDP traffic between the UE and a proxy is enabled using the MPQUIC functionality. In one embodiment, the processor 700 may be configured to support a means to transmit UDP packets to the proxy, the UDP packets encapsulated within datagram frames comprising an indication of an order of the datagram frames.

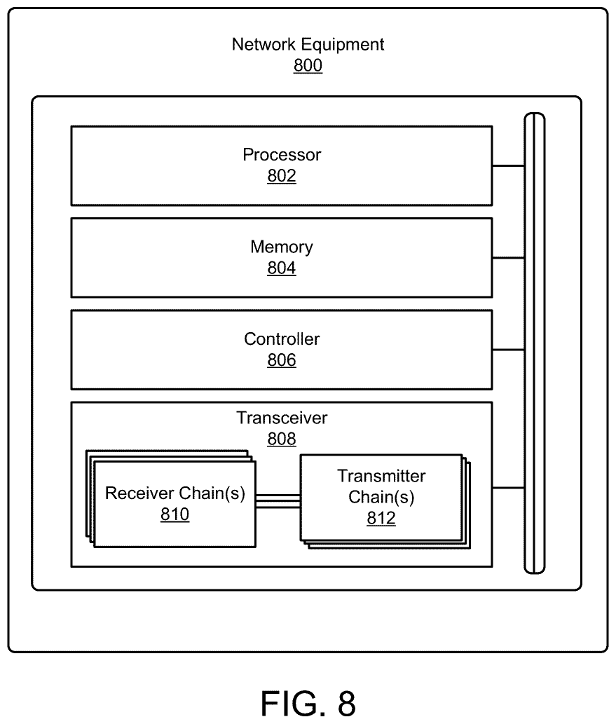

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

In one embodiment, the NE 800 may be configured to support a means to establish a communication session with a UE, the communication session comprising MPQUIC functionality, enable steering, switching, and splitting of UDP traffic between the UE and a proxy using the MPQUIC functionality, and transmit UDP packets between the UE and the proxy, the UDP packets encapsulated within datagram frames comprising an indication of an order of the datagram frames.

In one embodiment, the indication of the order of the datagram frames is included in each datagram frame. In one embodiment, the indication of the order of the datagram frames is predetermined prior to transmitting the datagram frames.

In one embodiment, the indication of the order of the datagram frames that is predetermined prior to transmitting the datagram frames is not included in the datagram frames, and wherein a value determined based on a number of bits is used for numbering the order of the datagram frames.

In one embodiment, the UE is an ATSSS device. In one embodiment, the communication session comprises an MA PDU session. In one embodiment, one or more of the datagram frames is received from a different source and ordered according to the indication.

In one embodiment, the indication in each of the datagram frames is located at a first octet after a context ID within the payload of each of the datagram frames, wherein the indication comprises a 32-bit integer set to a value that is greater than 0. In one embodiment, the indication in each of the datagram frames comprises a value determined based on a number of bits used for numbering the order of the datagram frames.

In one embodiment, a transport mode is used to transmit the UDP packets. In one embodiment, the transport mode is datagram mode 1. In one embodiment, the proxy is a UPF. In one embodiment, the datagram frames are QUIC datagram frames.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

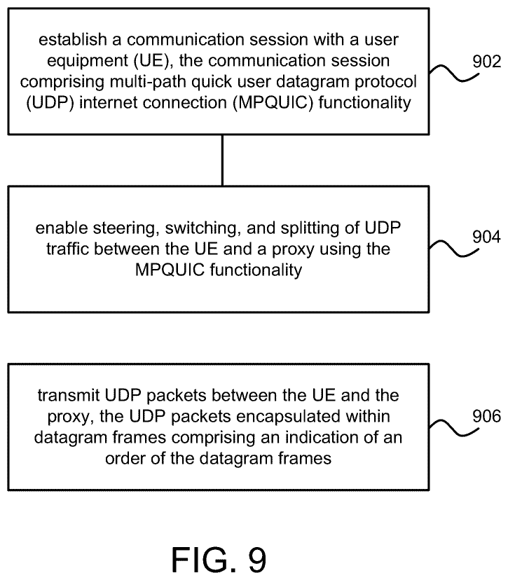

FIG. 9 illustrates a flowchart of a method in accordance with aspects of the present disclosure. The operations of the method may be implemented by a NE as described herein. In some implementations, the NE may execute a set of instructions to control the function elements of the NE to perform the described functions.

At 902, the method may establish a communication session with a UE, the communication session comprising MPQUIC functionality. The operations of 902 may be performed in accordance with examples as described herein. In some implementations, aspects of the operations of 902 may be performed by a NE as described with reference to FIG. 8.

At 904, the method may enable steering, switching, and splitting of UDP traffic between the UE and a proxy using the MPQUIC functionality. The operations of 904 may be performed in accordance with examples as described herein. In some implementations, aspects of the operations of 904 may be performed by an NE as described with reference to FIG. 8.

At 906, the method may transmit UDP packets between the UE and the proxy, the UDP packets encapsulated within datagram frames comprising an indication of an order of the datagram frames. The operations of 906 may be performed in accordance with examples as described herein. In some implementations, aspects of the operations of 906 may be performed by an NE as described with reference to FIG. 8.

It should be noted that the method described herein describes a possible implementation, and that the operations and the steps may be rearranged or otherwise modified and that other implementations are possible.

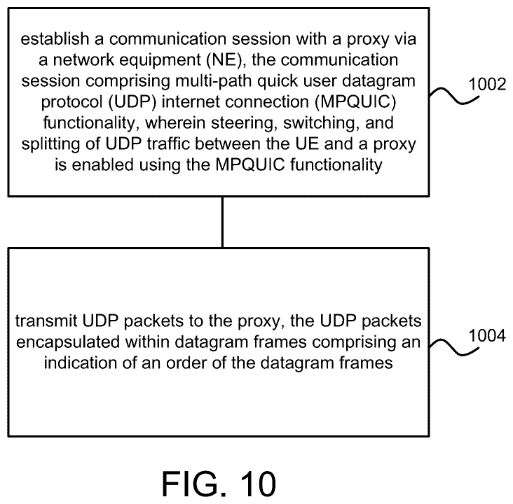

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may establish a communication session with a proxy via a NE, the communication session comprising MPQUIC functionality, wherein steering, switching, and splitting of UDP traffic between the UE and a proxy is enabled using the MPQUIC functionality. The operations of 1002 may be performed in accordance with examples as described herein. In some implementations, aspects of the operations of 1002 may be performed by a UE as described with reference to FIG. 6.

At 1004, the method may transmit UDP packets to the proxy, the UDP packets encapsulated within datagram frames comprising an indication of an order of the datagram frames. The operations of 1004 may be performed in accordance with examples as described herein. In some implementations, aspects of the operations of 1004 may be performed by a UE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
establish a communication session with a user equipment (UE), the communication session comprising multi-path quick user datagram protocol (UDP) internet connection (MPQUIC) functionality;
enable steering, switching, and splitting of UDP traffic between the UE and a proxy using the MPQUIC functionality; and
transmit UDP packets between the UE and the proxy, the UDP packets encapsulated within datagram frames comprising an indication of an order of the datagram frames.

2. The NE of claim 1, wherein the indication of the order of the datagram frames is included in each datagram frame.

3. The NE of claim 1, wherein the indication of the order of the datagram frames is predetermined prior to transmitting the datagram frames.

4. The NE of claim 3, wherein the indication of the order of the datagram frames that is predetermined prior to transmitting the datagram frames is not included in the datagram frames, and wherein a value determined based on a number of bits is used for numbering the order of the datagram frames.

5. The NE of claim 1, wherein the UE is an access traffic steering, switching, and splitting (ATSSS) device.

6. The NE of claim 1, wherein the communication session comprises a multi-access protocol data unit (MA PDU) session.

7. The NE of claim 1, wherein one or more of the datagram frames is received from a different source and ordered according to the indication.

8. The NE of claim 7, wherein the indication in each of the datagram frames is located at a first octet after a context ID within a payload of each of the datagram frames, wherein the indication comprises a 32-bit integer set to a value that is greater than 0.

9. The NE of claim 8, wherein the indication in each of the datagram frames comprises a value determined based on a number of bits used for numbering the order of the datagram frames.

10. The NE of claim 1, wherein a transport mode is used to transmit the UDP packets.

11. The NE of claim 10, wherein the transport mode is datagram mode 1.

12. The NE of claim 1, wherein the proxy is a user plane function (UPF).

13. The NE of claim 1, wherein the datagram frames are QUIC datagram frames.

14. A processor for wireless communication, comprising:
at least one controller coupled with at least one memory and configured to cause the processor to:
establish a communication session with a user equipment (UE), the communication session comprising multi-path quick user datagram protocol (UDP) internet connection (MPQUIC) functionality;
enable steering, switching, and splitting of UDP traffic between the UE and a proxy using the MPQUIC functionality; and
transmit UDP packets between the UE and the proxy, the UDP packets encapsulated within datagram frames comprising an indication of an order of the datagram frames.

15. The processor of claim 14, wherein the indication of the order of the datagram frames is included in each datagram frame.

16. The processor of claim 14, wherein the indication of the order of the datagram frames is predetermined prior to transmitting the datagram frames.

17. A method performed by a network equipment (NE), the method comprising:
establishing a communication session with a user equipment (UE), the communication session comprising multi-path quick user datagram protocol (UDP) internet connection (MPQUIC) functionality;
enabling steering, switching, and splitting of UDP traffic between the UE and a proxy using the MPQUIC functionality; and
transmitting UDP packets between the UE and the proxy, the UDP packets encapsulated within datagram frames comprising an indication of an order of the datagram frames.

18. The method of claim 17, wherein the indication of the order of the datagram frames is included in each datagram frame.

19. The method of claim 17, wherein the indication of the order of the datagram frames is predetermined prior to transmitting the datagram frames.

20. A user equipment (UE) for wireless communication, comprising:
at least one memory; and
at least one processor coupled with the at least one memory and configured to cause the UE to:
establish a communication session with a proxy via a network equipment (NE), the communication session comprising multi-path quick user datagram protocol (UDP) internet connection (MPQUIC) functionality, wherein steering, switching, and splitting of UDP traffic between the UE and a proxy is enabled using the MPQUIC functionality; and
transmit UDP packets to the proxy, the UDP packets encapsulated within datagram frames comprising an indication of an order of the datagram frames.
